(19) United States
(12) Patent Application Publication
(10) Pub. No.: US 2014/0285284 A1
(43) Pub. Date: Sep. 25, 2014

(54) BROADBAND BUTLER MATRIX DEVICE

(71) Applicant: Electronics and Telecommunications Research Institute, Daejeon (KR)

(72) Inventor: Joung Myoun KIM, Daejeon (KR)

(21) Appl. No.: 13/915,315

(22) Filed: Jun. 11, 2013

(30) Foreign Application Priority Data
Mar. 19, 2013 (KR) 10-2013-0029210

(51) Int. Cl. H01P 5/22

(52) U.S. Cl. CPC H01P 1/184
USPC 333/117

(57) ABSTRACT

A broadband butler matrix device includes a 90° branch-line hybrid coupler having an input terminal provided at one side thereof and configured to receive an input signal through the input terminal, and distribute and output the received signal such that the distributed signals have a phase difference of 90°. Further, the broadband butler matrix device includes a 45° broadband phase shifter configured to change the phases of the signals outputted through the 90° branch-line hybrid coupler, using an open and short stub having an electrical length of 45°.

### CROSS-REFERENCE TO RELATED APPLICATION(S)

The present invention claims priority of Korean Patent Application No. 10-2013-0029210, filed on Mar. 19, 2013, which is incorporated herein by reference.

### FIELD OF THE INVENTION

The present invention relates to a broadband butler matrix device, and more particularly, to a broadband butler matrix device which is an ultra-high frequency part used for a multi-beam forming antenna.

### BACKGROUND OF THE INVENTION

With the diversification of wireless communication services, demand for wireless frequency resources has been rapidly increased, and multiple input multiple output (MIMO) communication technology based on a broadband high-speed data service has been essentially required.

According to the MIMO communication technology, multiple antennas are used to perform independent multiple channel transmissions, thereby increasing a channel capacity. Furthermore, multiple channels having directional characteristics and high isolation characteristics need to be formed for broadband MIMO antennas for high-speed data transmission.

For this configuration, much attention has been paid to a multi-beam forming technology using a broadband butler matrix and a broadband array antenna. However, the conventional butler matrix device has a disadvantage in that phase differences between output terminals thereof are not uniform within an operating frequency band.

Accordingly, when the conventional butler matrix device is utilized for the multi-beam forming antenna, electrical characteristics may be degraded depending on an operating frequency.

### SUMMARY OF THE INVENTION

In view of the above, the present invention provides a broadband butler matrix device using a phase shifter structure having broadband characteristics.

Further, the present invention provides a broadband butler matrix device which is capable of equally maintaining specific phase differences of output terminals of a butler matrix.

In accordance with an embodiment of the present invention, there is provided a broadband butler matrix device, including: a 90° branch-line hybrid coupler having an input terminal provided at one side thereof and configured to receive an input signal through the input terminal, and distribute and output the received signal such that the distributed signals have a phase difference of 90°; and a 45° broadband phase shifter configured to change the phases of the signals outputted through the 90° branch-line hybrid coupler, using an open and short stub having an electrical length of 45°.

Further, the broadband butler matrix device may further comprise a 0° broadband phase shifter used as a reference.

Further, the 0° broadband phase shifter may comprise one main transmission line and four stub transmission lines.

Further, the 45° broadband phase shifter may comprise a main transmission line having an electrical length of 180°; and a stub transmission line having an electrical length of 45°, and characteristic impedances of the main transmission line and the stub transmission may be adjusted to control a phase gradient.

Further, the 45° broadband phase shifter may comprise three main transmission lines and four stub transmission lines.

Further, the broadband butler matrix device may further comprise a 22.5° broadband phase shifter based on the output phase characteristic of the 0° broadband phase shifter.

Further, the 22.5° broadband phase shifter may comprise three main transmission lines and four stub transmission lines.

Further, the broadband butler matrix device may further comprise a 67.5° broadband phase shifter based on the output phase characteristic of the 0° broadband phase shifter.

Further, the 67.5° broadband phase shifter may comprise three main transmission lines and four stub transmission lines.

Further, the input terminal and output terminals may be isolated from each other within an operating band between.

Further, the broadband butler matrix device may have a 4×4 butler matrix comprising four broadband branch-line hybrid couplers.

Further, the broadband butler matrix device may have an 8×8 butler matrix comprising 12 broadband branch-line hybrid couplers.

The broadband phase shifter device may be directly utilized to an antenna device for forming broadband multiple beams. Furthermore, the broadband phase shifter device may be widely applied to the MIMO antenna technology having broadband multiple beam channels suitable for next-generation high-speed wireless communication data transmission.

### BRIEF DESCRIPTION OF THE DRAWINGS

The objects and features of the present invention will become apparent from the following description of embodiments given in conjunction with the accompanying drawings, in which:

FIG. 1 is a configuration diagram of a broadband butler matrix device in accordance with an embodiment of the present invention, for example, a 4×4 broadband butler matrix device;

FIG. 2 is a detailed configuration diagram of a 90° broadband branch-line hybrid coupler in the broadband butler matrix device of FIG. 1;

FIG. 3 is a detailed configuration diagram of a 45° broadband phase shifter in the broadband butler matrix device of FIG. 1;

FIG. 4 is a detailed configuration diagram of a 0° broadband phase shifter in the broadband butler matrix device of FIG. 1;

FIGS. 5 to 10 are graphs illustrating results obtained by simulating electrical characteristics of the 4×4 broadband butler matrix structure of FIG. 1;

FIG. 11 is a configuration diagram of a broadband butler matrix device in accordance with an embodiment of the present invention, for example, an 8×8 broadband butler matrix device;

FIG. 12 is a detailed configuration diagram of a 67.5° broadband phase shifter in the broadband butler matrix device of FIG. 11;

FIG. 13 is a detailed configuration diagram of a 22.5° broadband phase shifter in the broadband butler matrix device of FIG. 11; and

FIGS. 14 to 21 are graphs illustrating results obtained by simulating electrical characteristics of the 8×8 broadband butler matrix structure of FIG. 11.

### DETAILED DESCRIPTION OF THE EMBODIMENTS

Hereinafter, exemplary embodiments of the present invention will be described below in more detail with reference to the accompanying drawings. The present invention may, however, be embodied in different forms, and should not be construed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Furthermore, the terms described below have been defined by considering functions in embodiments of the present invention, and may be defined differently depending on a user or operator's intention or practice. Therefore, the definitions of such terms are based on the overall descriptions in the present specification.

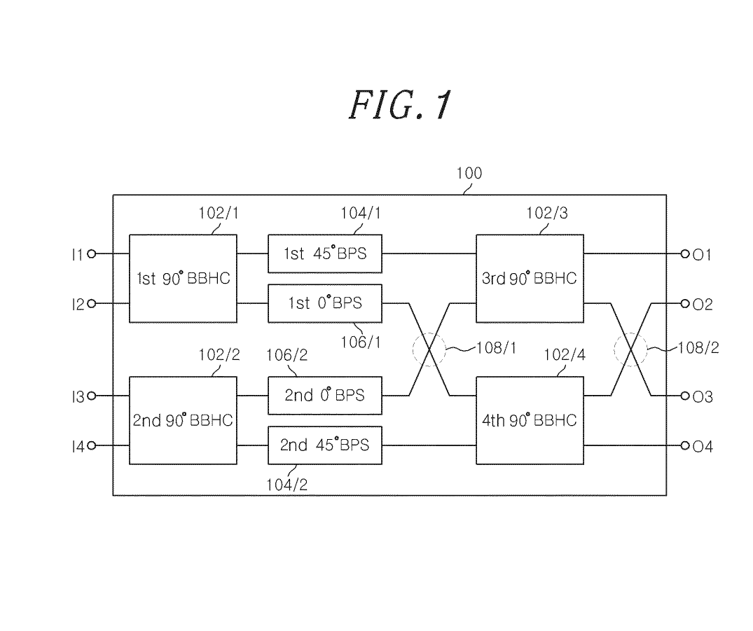

FIG. 1 is a configuration diagram of a broadband butler matrix device in accordance with an embodiment of the present invention, for example, a 4×4 broadband butler matrix device.

Referring to FIG. 1, the broadband butler matrix device 100 has equal numbers M of input and output terminals where M is 4, 8, 16, . . . . The respective input terminals are isolated from each other within an operating band, and the respective output terminals are also isolated from each other within an operating band.

A signal inputted to each of the input terminals is distributed as the same power (1/M) to the output terminals through independent internal circuit paths. At this time, the output phases of the respective output signals have specific linear phase characteristics different from each other depending on the excitation position of the input terminal.

The 4×4 broadband butler matrix device 100 of FIG. 1 may include four 90° broadband branch-line hybrid couplers 102/1 to 102/4, two 45° broadband phase shifters 104/1 and 104/2, two 0° reference broadband phase shifters 106/1 and 106/2, and two RF crossovers 108/1 and 108/2.

Here, the RF crossovers 108/1 and 108/2 may indicate that two RF signals cross each other without degrading electrical characteristic and without being coupled to each other.

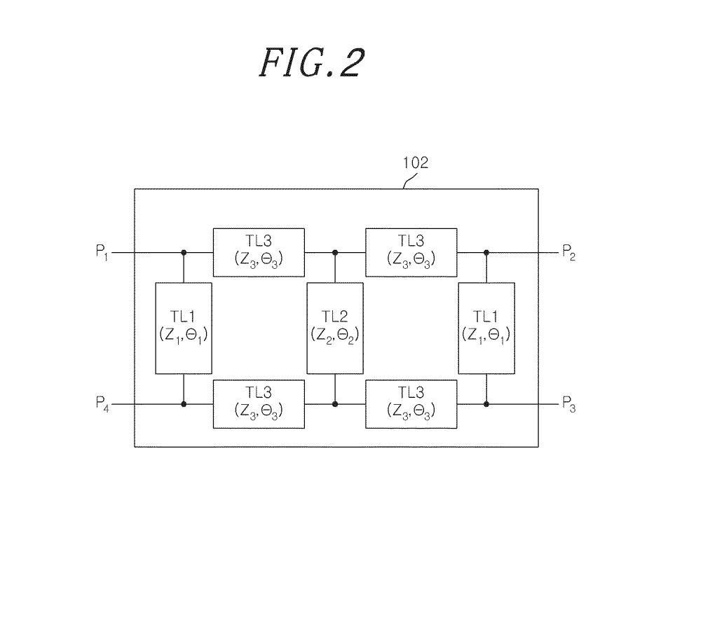

Referring to FIG. 2, each of the 90° broadband branch-line hybrid couplers 102/1 to 102/4 may include seven transmission lines TL1 to TL3.

The configuration of FIG. 2 is only an example, and the number of transmission lines may be varied as occasion demands. For example, the number of transmission lines may be enlarged to expand the operating band, and this may be easily understood by those skilled in the art.

In an embodiment, electrical design variables of the respective transmission lines may be set follows: Z₁=105.55Ω, θ₁=90° (TL1), Z₂=41.67Ω, θ₂=90° (TL2), Z₃=34.87Ω, and θ₃=90° (TL3).

Referring to FIG. 2, the 90° broadband branch-line hybrid coupler 102 has four input/output terminals P₁, P₂, P₃, and P₄, and operates in a broadband of 40% or more. For example, a signal inputted to the input terminal P₁ is distributed as the same magnitude (1/2) to the output terminals P₂ and P₃, and the output terminals P₂ and P₃ have a phase difference of 90°.

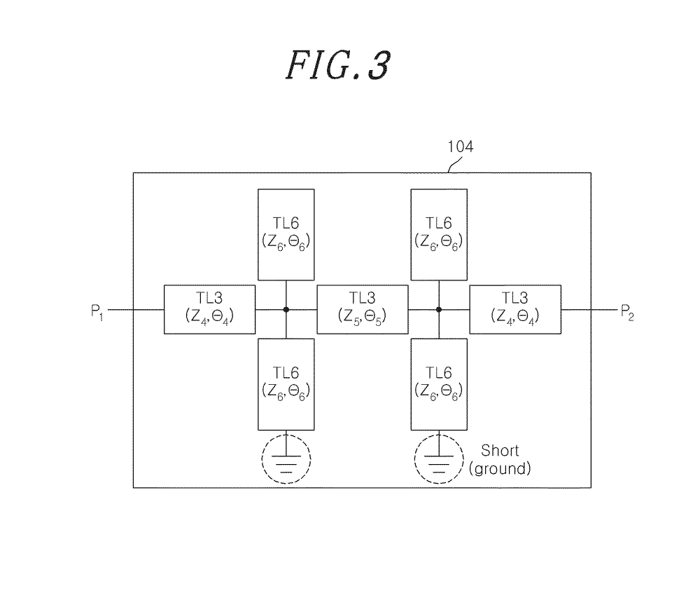

Referring to FIG. 3, each of the two 45° broadband phase shifters 104/1 and 104/2 may include seven transmission lines TL4 to TL6.

Among the seven transmission lines, three transmission lines may be configured as main transmission lines, and the other four transmission lines may be configured as open and short stubs. In an embodiment, electrical design variables of the respective transmission lines may be set as follows: Z₄=50.00Ω, θ₄=22.5° (TL4), Z₅=71.35Ω, θ₅=180° (TL5), Z₆=83.7Ω, and θ₆=45° (TL6).

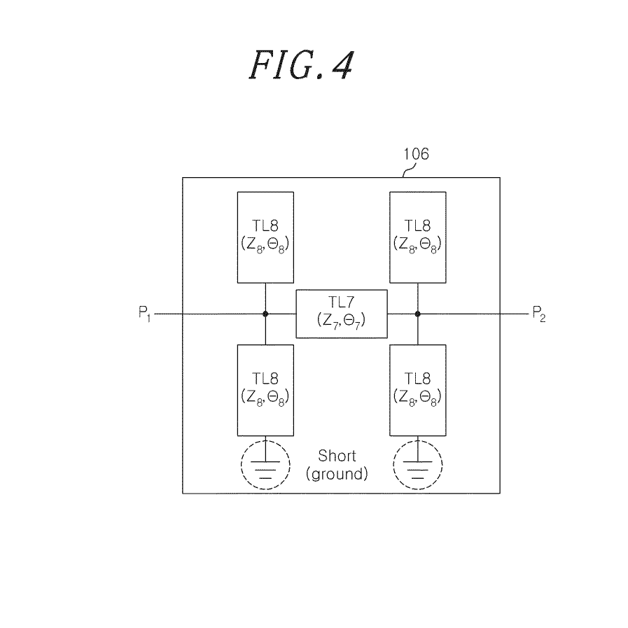

Referring to FIG. 4, each of the two 0° broadband phase shifters 106/1 and 106/2 may include five transmission lines TL7 and TL8.

Among the five transmission lines, one transmission line may be configured as a main transmission line, and the other four transmission lines may be configured as open and short stubs. In an embodiment, electrical design variables of the respective transmission lines may be set as follows: Z₇=61.90Ω, θ₇=180° (TL7), Z₈=125.56Ω, and θ₈=45° (TL8).

The output phase of the 0° broadband phase shifter 106 serves as a reference phase for all phase shifters used in the 4×4 broadband butler matrix device 100. That is, the output phase of the 45° broadband phase shifter 104 may be uniformly delayed by 45° in a broad band of 40% or more with respect to the reference phase of the 0° broadband phase shifter 106.

Table 1 shows an input/output amplitude/phase relationship of the 4×4 broadband butler matrix device.

TABLE 1

| Output | | | | |
|---|---|---|---|---|
| terminal | O1 | O2 | O3 | O4 |
| Input | amplitude/ | amplitude/ | amplitude/ | amplitude/ |
| terminal | phase | phase | phase | phase |
| I1 | 0.25/0° | 0.25/−45° | 0.25/−90° | 0.25/−135° |
| I2 | 0.25/0° | 0.25/135° | 0.25/270° | 0.25/45° |
| I3 | 0.25/0° | 0.25/−135° | 0.25/−270° | 0.25/−45° |
| I4 | 0.25/0° | 0.25/45° | 0.25/90° | 0.25/135° |

Referring to Table 1, it can be seen that a signal inputted to each of the input terminals I1 to I4 is distributed as the same power (0.25), and the output phases of the respective output signals have a phase step characteristic that they lag or lead the reference phase by ±45° or ±135°, depending on the input terminals.

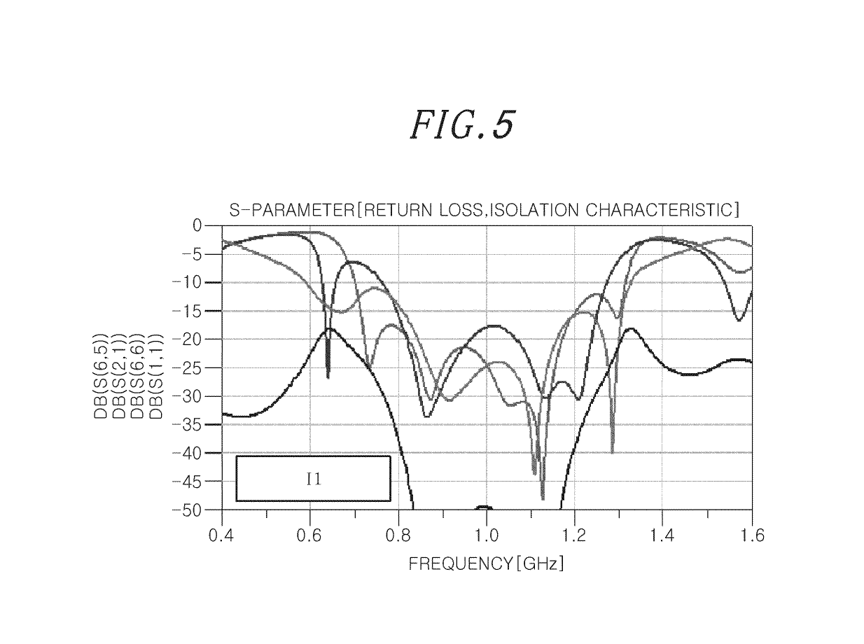

FIGS. 5 to 10 illustrate results obtained by simulating the electrical characteristics of the 4×4 broadband butler matrix structure in accordance with the embodiment of the present invention. FIGS. 5 to 10 illustrate electrical characteristics of the respective output terminals when a signal is applied to the input terminals I1 and I3.

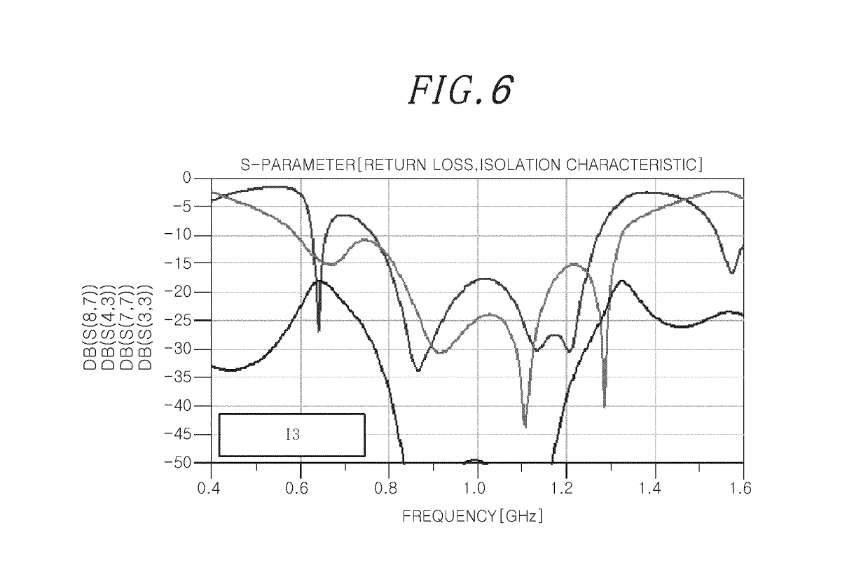

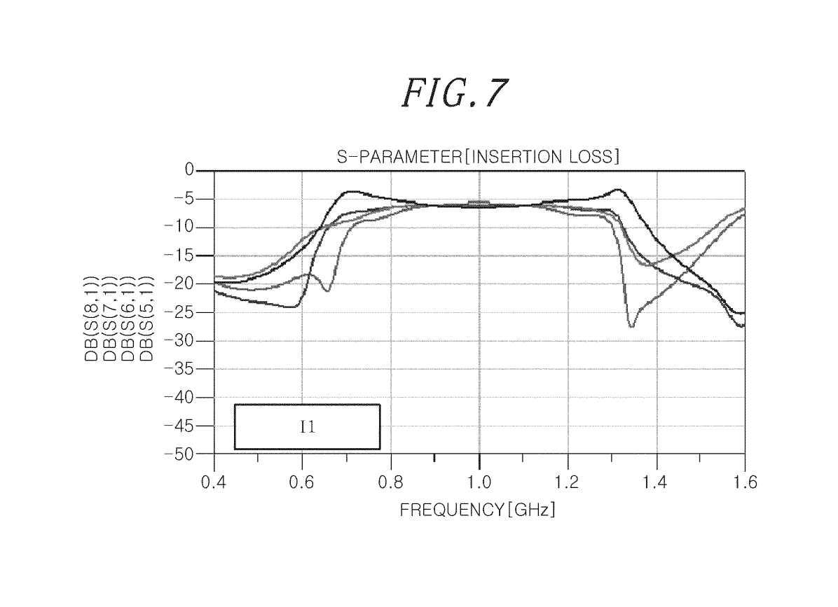

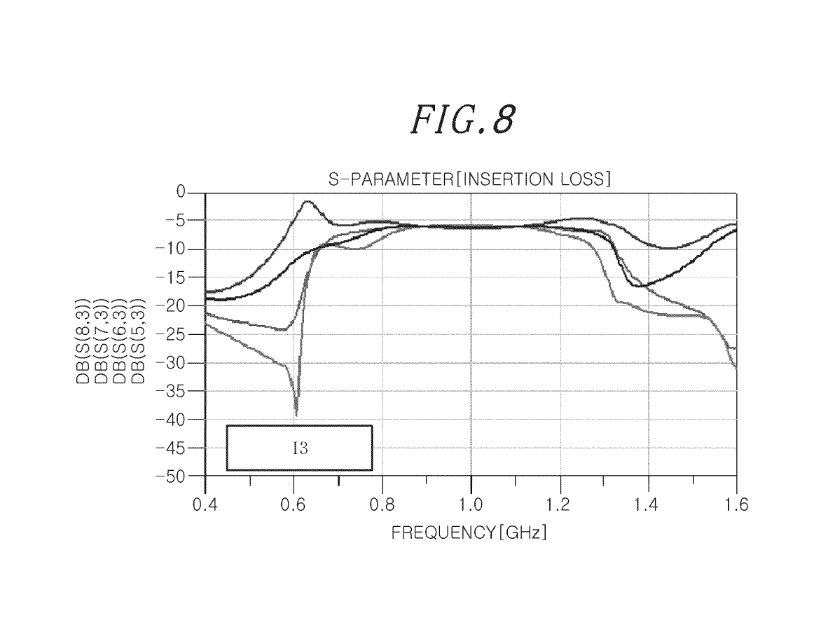

FIGS. 5 and 6 illustrate simulation results of input/output return loss characteristics (based on VSWR 1.5:1) and isolation characteristics between terminals (20 dB or more), and FIGS. 7 and 8 simulation results of illustrate insertion loss characteristics (±0.5 dB or less, distribution loss excluded). The simulation results operate in a band of 30% or more around the normalized center frequency (f=1 GHz).

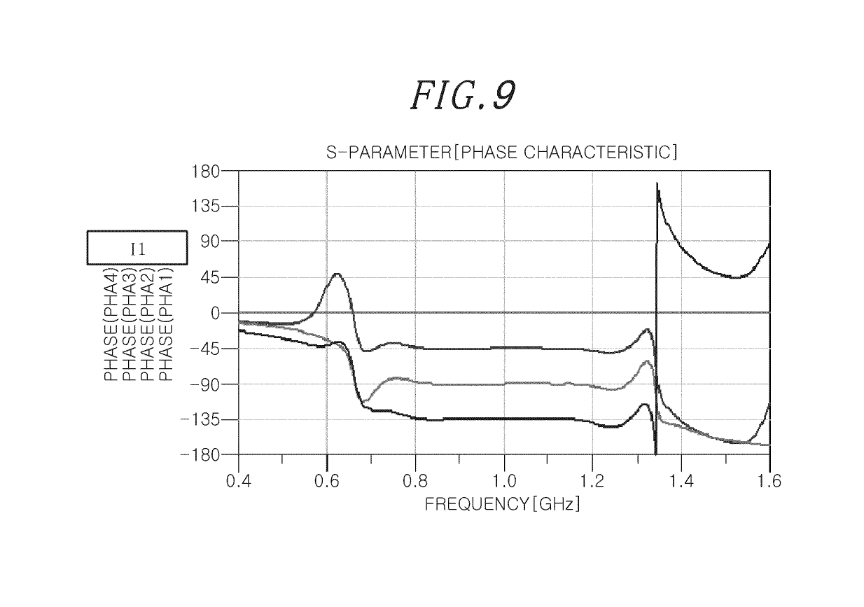

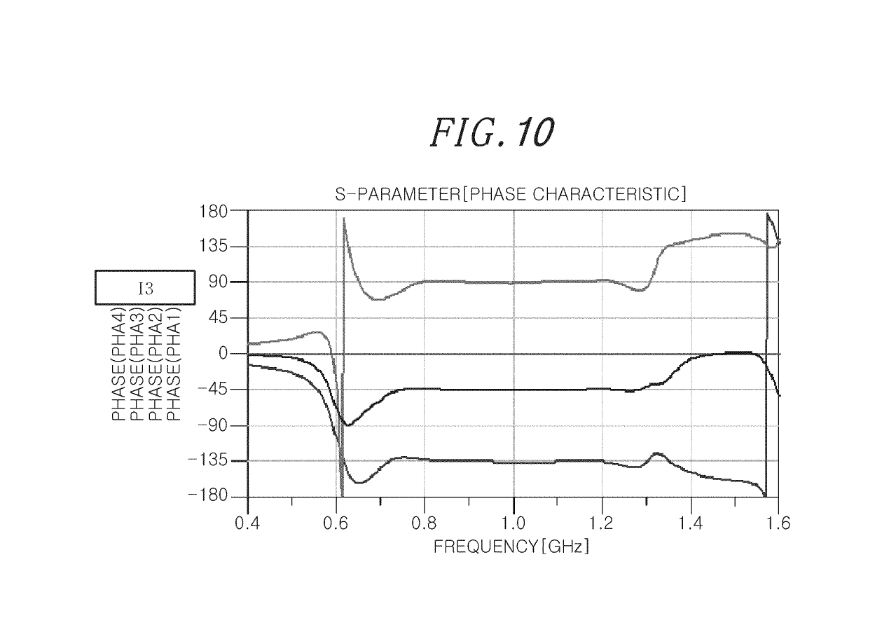

FIGS. 9 and 10 illustrate simulation results of phase characteristics where an error is ±2° or less. When a signal is inputted to the input terminal I1, the signal exhibits a phase lag of 45°, and when a signal is inputted to the input terminal I3, the signal exhibits a phase lag of 135°. Furthermore, uniform phase characteristics with may be obtained in a broad band of 40% or more with respect to the reference phase around the normalized center frequency (f=1 GHz).

Here, a first phase PHA1 indicates the phase reference of the output terminal O1, a second phase PHA2 indicates a phase characteristic of the output terminal O2 with respect to the phase reference of the output terminal O1, a third phase PHA3 indicates a phase characteristic of the output terminal O3 with respect to the phase reference of the output terminal O1, and a fourth phase PHA4 indicates a phase characteristic of the output terminal O4 with respect to the phase reference of the output terminal O1.

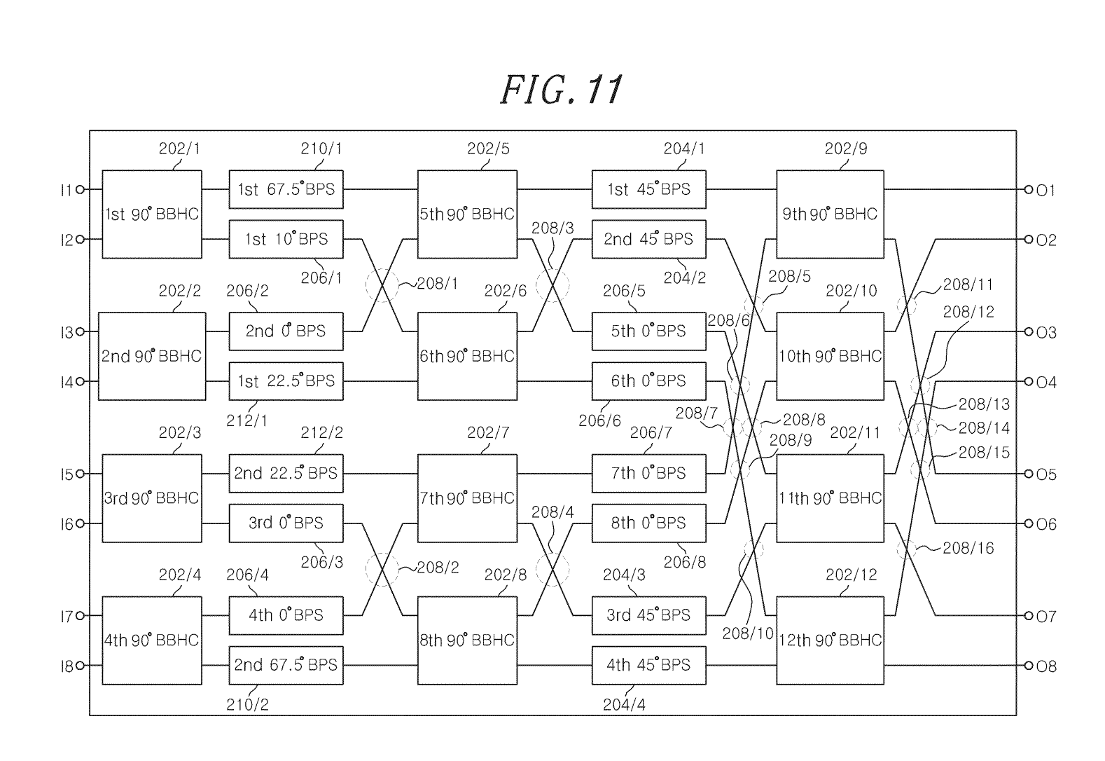

FIG. 11 is a configuration diagram of a broadband butler matrix device in accordance with another embodiment of the present invention, for example, an 8×8 broadband butler matrix device.

The broadband butler matrix device 200 of FIG. 11 may include 12 90° broadband branch-line hybrid couplers 202/1 to 202/12, four 45° broadband phase shifters 204/1 to 204/4, eight 0° reference broadband phase shifters 206/1 to 206/8, two 67.5° broadband phase shifters 210/1 and 210/2, two 22.5° broadband phase shifters 212/1 and 212/2, and 16 RF crossovers 208/1 to 208/16.

Here, the RF crossovers 208/1 to 208/16 may indicate that two RF signals cross each other without degrading electrical characteristic and without being coupled to each other.

The 90° broadband branch-line hybrid couplers 202/1 to 202/12, the 45° broadband phase shifters 204/1 to 204/4, and the 0° reference broadband phase shifters 206/1 to 206/8 constituting the 8×8 broadband butler matrix device may be configured in the same manner as those of the 4×4 broadband butler matrix device of FIG. 1. Therefore, the detailed descriptions thereof are omitted herein.

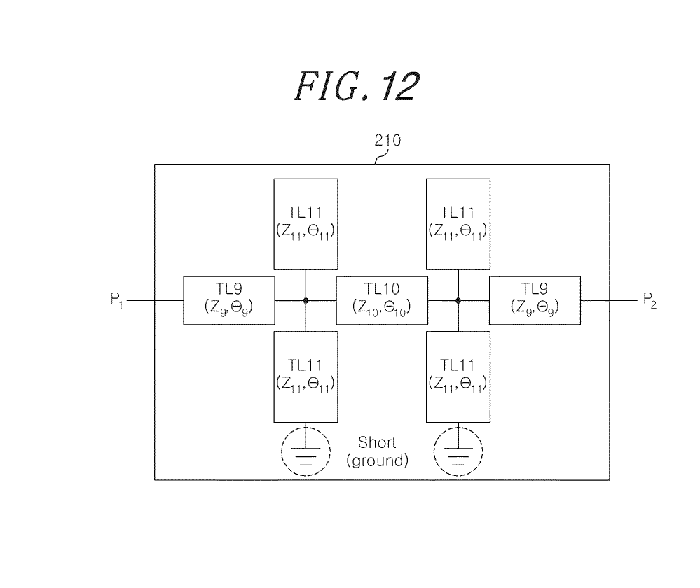

Referring to FIG. 12, each of the two 67.5° broadband phase shifters 210/1 and 210/2 may include seven transmission lines TL9 to TL11.

Among the seven transmission lines TL9 to TL11, three transmission lines may be configured as main transmission lines, and the other four transmission lines may be configured as open and short stubs. In an embodiment, electrical design variables of the respective transmission lines may be set as follows: Z₉=50.00Ω, θ₉=33.75° (TL9), Z₁₀=57.18Ω, θ₁₀=180° (TL10), Z₁₁=167.41Ω, and θ₁₁=45° (TL11).

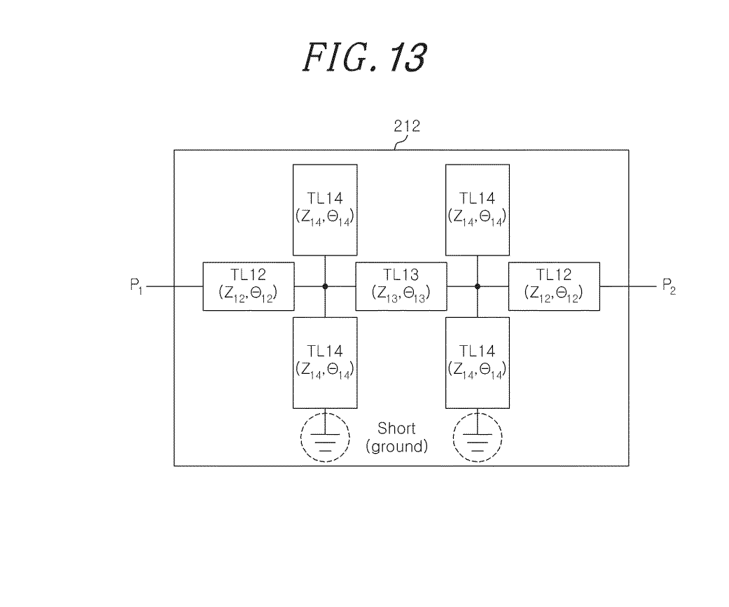

Referring to FIG. 13, each of the two 22.5° broadband phase shifters 212/1 and 212/2 may include seven transmission lines TL12 and TL14.

Among the seven transmission lines TL12 and TL14, three transmission lines may be configured as a main transmission line, and the other four transmission lines may be configured as open and short stubs. In an embodiment, electrical design variables of the respective transmission lines may be set as follows: Z₁₂=50.00Ω, θ₁₂=11.25° (TL9), Z₁₃=66.63Ω, θ₁₃=180° (TL10), Z₁₄=100.44Ω, and θ₁₄=45° (TL14).

Table 2 shows the input/output amplitude/phase relationship of the 8×8 broadband butler matrix device.

TABLE 2

| | O1 | O2 | O3 | O4 | O5 | O6 | O7 | O8 |
|---|---|---|---|---|---|---|---|---|
| Output | amplitude/ | amplitude/ | amplitude/ | amplitude/ | amplitude/ | amplitude/ | amplitude/ | amplitude/ |
| input | phase | phase | phase | phase O1 | phase | phase | phase | phase |
| I1 | 0.125/0° | 0.125/−22.7° | 0.125/−45° | 0.125/−67.5° | 0.125/−90° | 0.125/−112.5° | 0.125/−135° | 0.125/−157.5° |
| I2 | 0.125/0° | 0.125/157.5° | 0.125/315° | 0.125/112.5° | 0.125/270° | 0.125/67.5° | 0.125/225° | 0.125/22.5° |
| I3 | 0.125/0° | 0.125/−112.5° | 0.125/−225° | 0.125/−337.5° | 0.125/−90° | 0.125/−202.5° | 0.125/−315° | 0.125/−67.5° |
| I4 | 0.125/0° | 0.125/67.5° | 0.125/135° | 0.125/202.5° | 0.125/270° | 0.125/337.5° | 0.125/45° | 0.125/112.5° |
| I5 | 0.125/0° | 0.125/−67.5° | 0.125/−135° | 0.125/−202.5° | 0.125/−270° | 0.125/−337.5° | 0.125/−45° | 0.125/−112.5° |
| I6 | 0.125/0° | 0.125/112.5° | 0.125/225° | 0.125/337.5° | 0.125/90° | 0.125/202.5° | 0.125/315° | 0.125/67.5° |
| I7 | 0.125/0° | 0.125/−157.5° | 0.125/−315° | 0.125/−112.5° | 0.125/−270° | 0.125/−67.5° | 0.125/−225° | 0.125/−22.5° |
| I8 | 0.125/0° | 0.125/22.5° | 0.125/45° | 0.125/67.5° | 0.125/90° | 0.125/112.5° | 0.125/135° | 0.125/157.5° |

Referring to Table 2, it can be seen that a signal inputted to each of the input terminals I1 to I8 is distributed as the same power (0.125), and the output phases of the respective output signals have a phase step characteristic that they lag or lead the reference phase by ±22.5°, ±67.5°, ±112.5°, or ±157.5°, depending on the input terminals.

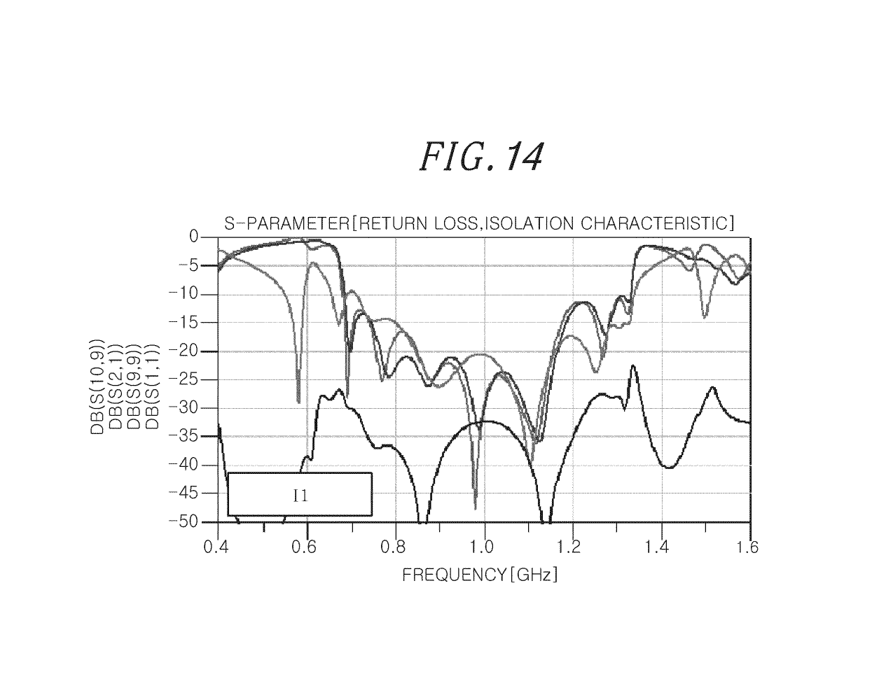

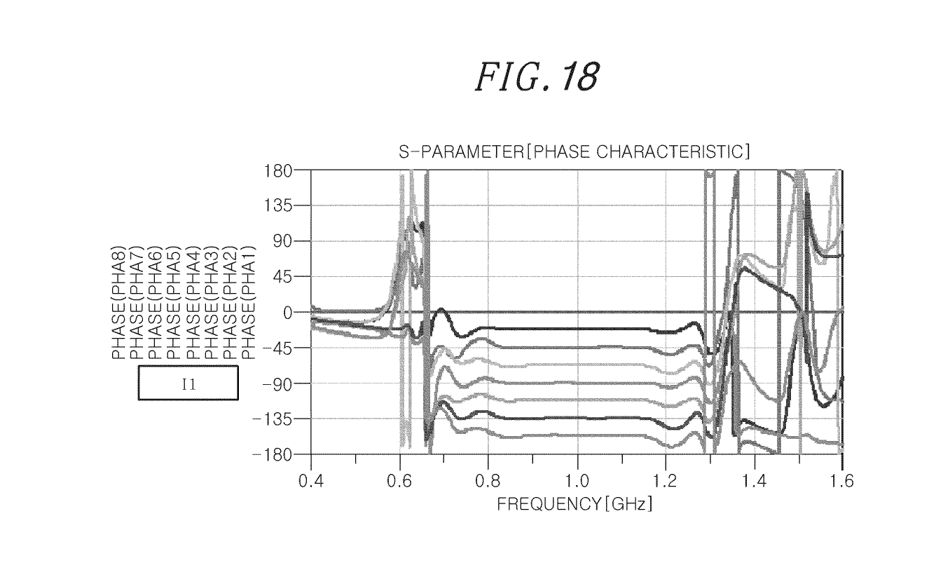

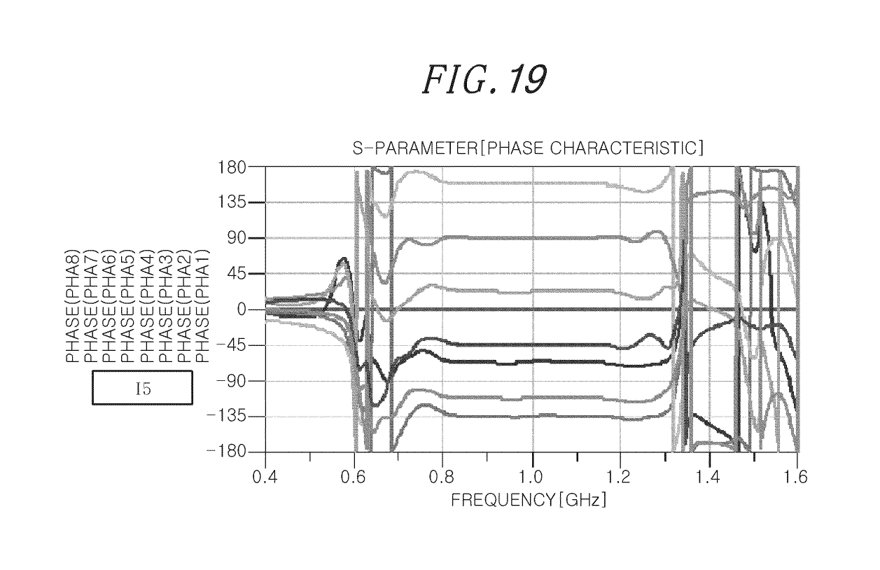

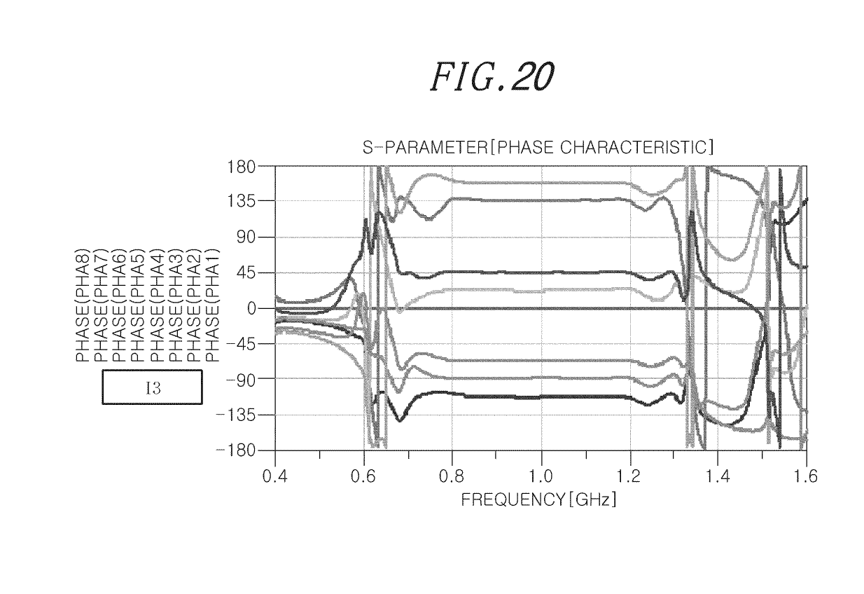

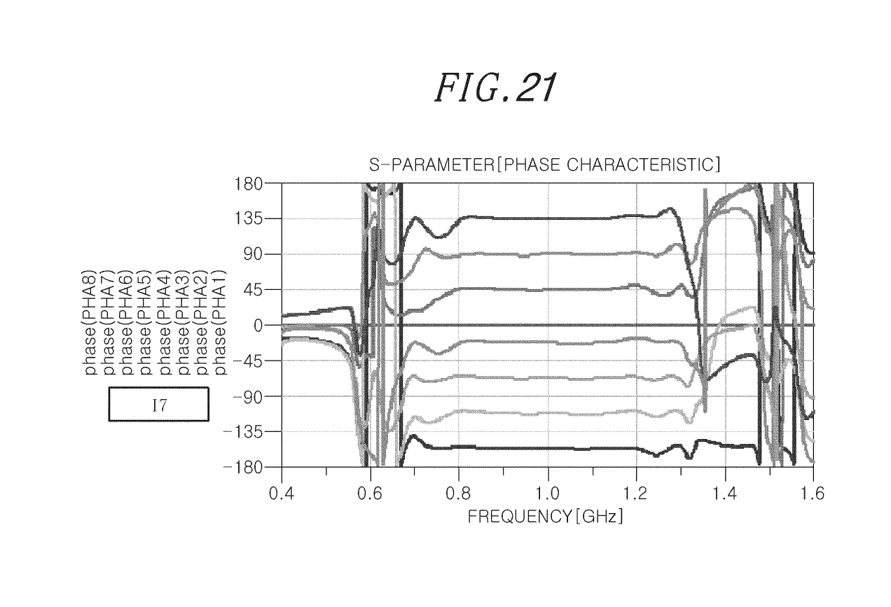

FIGS. 14 to 21 are graphs illustrating results obtained by simulating the electrical characteristics of the 8×8 broadband butler matrix device of FIG. 11.

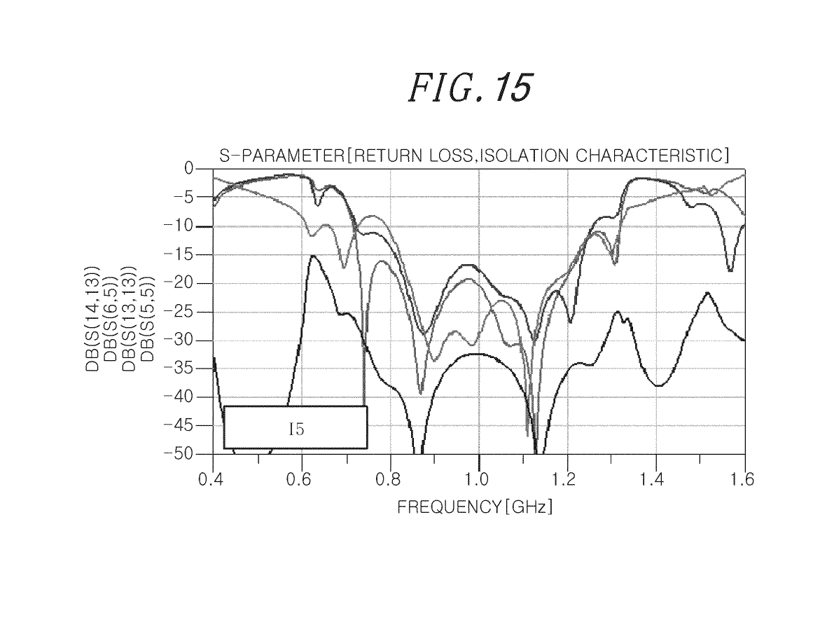

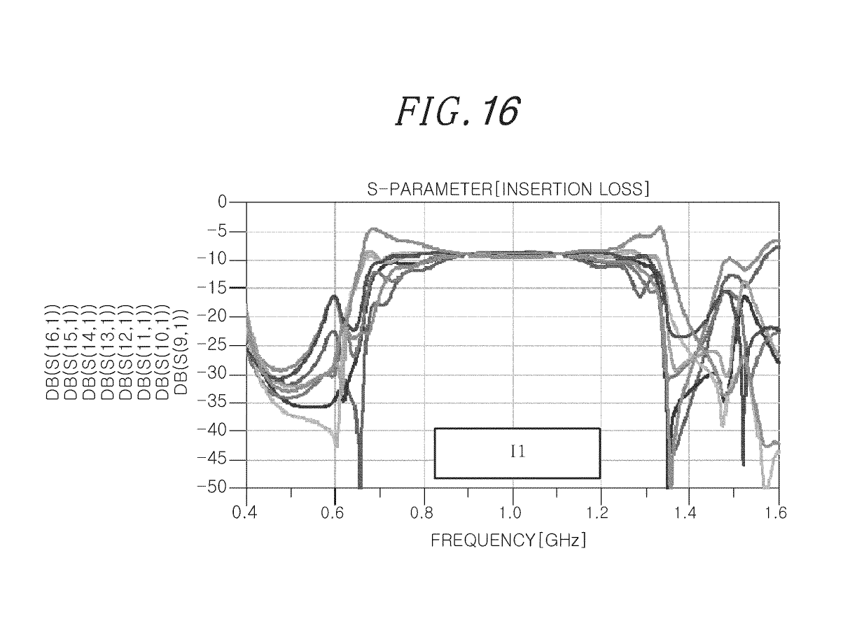

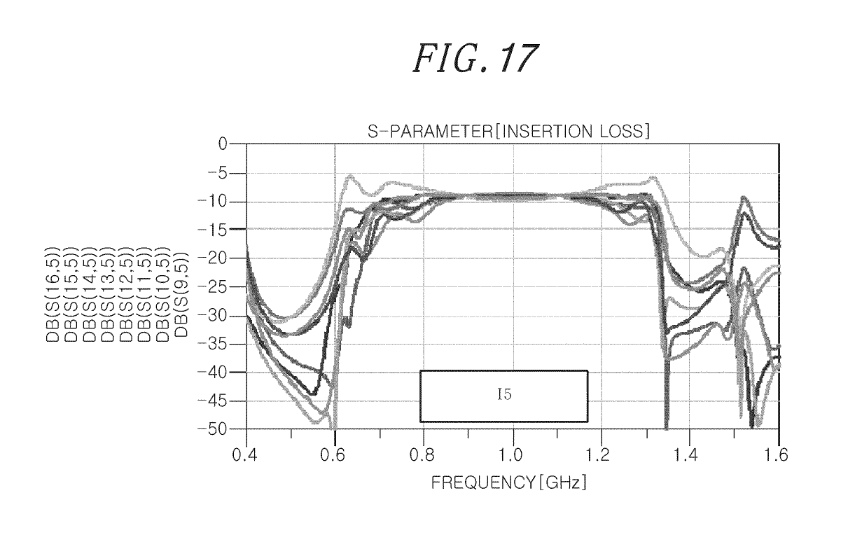

FIGS. 14 and 15 illustrate simulation results of input/output return loss (based on VSWR 1.5:1) and isolation characteristics between terminals, and FIGS. 16 and 17 illustrate simulation results of insertion loss (±1 dB or less, distribution loss excluded). The simulation results operate in a band of 30% or more around the normalized center frequency (f=1 GHz).

FIGS. 17 to 21 illustrate simulation results of phase characteristics where an error is ±2° or less. When a signal is inputted to the input terminal I1, the signal exhibits a phase lag of 22.5°. When a signal is inputted to the input terminal I3, the signal exhibits a phase lag of 112.5°. When a signal is inputted to the input terminal I5, the signal exhibits a phase lag of 67.5°. When a signal is inputted to the input terminal I7, the signal exhibits a phase lag of 157.5°. Furthermore, uniform phase characteristics with may be obtained in a broad band of 30% or more with respect to the reference phase around the normalized center frequency (f=1 GHz).

Here, a first phase PHA1 indicates a phase reference of the output terminal O1, a second phase PHA2 indicates a phase characteristic of the output terminal O2 with respect to the phase reference of the output terminal O1, a third phase PHA3 indicates a phase characteristic of the output terminal O3 with respect to the phase reference of the output terminal O1, a fourth phase PHA4 indicates a phase characteristic of the output terminal O4 with respect to the phase reference of the output terminal O1, a fifth phase PHA5 indicates a phase characteristic of the output terminal with respect to the phase reference of the output terminal O1, a sixth phase PHA6 indicates a phase characteristic of the output terminal O6 with respect to the phase reference of the output terminal O1, a seventh phase PHA7 indicates a phase characteristic of the output terminal with respect to the phase reference of the output terminal O1, and an eighth phase PHA8 indicates a phase characteristic of the output terminal O8 with respect to the phase reference of the output terminal O1.

In accordance with the above-described embodiment of the present invention, the broadband phase shifter structure using the broadband 90° branch-line hybrid couplers and the open and short stubs having an electrical length of 45° is used to implement the broadband butler matrix device. Accordingly, specific phase differences between the respective output terminals of the broadband butler matrix device may be equally maintained in a broad band of 40% or more.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A broadband butler matrix device, comprising:
a 90° branch-line hybrid coupler having an input terminal provided at one side thereof and configured to receive an input signal through the input terminal, and distribute and output the received signal such that the distributed signals have a phase difference of 90°; and
a 45° broadband phase shifter configured to change the phases of the signals outputted through the 90° branch-line hybrid coupler, using an open and short stub having an electrical length of 45°.

2. The broadband butler matrix device of claim 1, further comprising a 0° broadband phase shifter used as a reference.

3. The broadband butler matrix device of claim 2, wherein the 0° broadband phase shifter comprises one main transmission line and four stub transmission lines.

4. The broadband butler matrix device of claim 1ₛₜ, wherein the 45° broadband phase shifter comprises:
a main transmission line having an electrical length of 180°; and
a stub transmission line having an electrical length of 45°,
wherein characteristic impedances of the main transmission line and the stub transmission are adjusted to control a phase gradient.

5. The broadband butler matrix device of claim 4, wherein the 45° broadband phase shifter comprises three main transmission lines and four stub transmission lines.

6. The broadband butler matrix device of claim 2, further comprising a 22.5° broadband phase shifter based on the output phase characteristic of the 0° broadband phase shifter.

7. The broadband butler matrix device of claim 6, wherein the 22.5° broadband phase shifter comprises three main transmission lines and four stub transmission lines.

8. The broadband butler matrix device of claim 2, further comprising a 67.5° broadband phase shifter based on the output phase characteristic of the 0° broadband phase shifter.

9. The broadband butler matrix device of claim 8, wherein the 67.5° broadband phase shifter comprises three main transmission lines and four stub transmission lines.

10. The broadband butler matrix device of claim 1, wherein the input terminal and output terminals are isolated from each other within an operating band between.

11. The broadband butler matrix device of claim 1, wherein the broadband butler matrix device has a 4×4 butler matrix comprising four broadband branch-line hybrid couplers.

12. The broadband butler matrix device of claim 1, wherein the broadband butler matrix device has an 8×8 butler matrix comprising 12 broadband branch-line hybrid couplers.
